(19) United States
(12) Patent Application Publication
(10) Pub. No.: US 2003/0146528 A1
(43) Pub. Date: Aug. 7, 2003

(54) Method for manufacturing microlens light guide

(76) Inventor: Kuo-Jui Huang, Jia Yih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/060,355

(22) Filed: Feb. 1, 2002

(51) Int. Cl. B29D 11/00

(52) U.S. Cl. 264/2.5; 205/70

(57) ABSTRACT

A method for manufacturing microlens light guide, which mainly includes forming patterns, in a concave or convex shape, on a plastic or wax mold substrate by mechanical processing or non-traditional processing, plasticizing the patterns to microlens patterns, as a master mold for later use, by thermal flow, electroforming to make mold core for later use, and finally injection molding to make microlens light guide.

### BACKGROUND OF INVENTION

1. Field of the Invention

The present invention relates to a method for manufacturing microlens light guide.

2. Description of the Prior Art

As described in R. O. C. Patent No. 110552, the traditional method for manufacturing microlens light guide mainly comprises the procedures that include applying photo resist of viscosity between 200 and 1200 centipoises onto a flat substrate, forming a photo resist layer between 5 and 30 μm by spin coating, exposure, development, effecting surface conductivity on the photo resist layer, electroforming, forming a punching die with surface micro-roughness, stripping to remove the photo resist layer, and forming a mold for making the light guide.

U.S. Pat. No. 5,776,636 describes the manufacturing of microlens light guide mainly by the use of photolithography to make microlens patterns, then electroforming to make a mold, and finally injection molding.

U.S. Pat. No. 6,002,464 provides a process of photolithography, in which a diffuser_is basically composed of microlens to generate uniform light.

The above-mentioned conventional processes for manufacturing microlens light guide all relate to the use of photolithography for making microlens pattern, followed by electroforming for making the mold and injection molding for making the microlens light guide.

Since photolithography process involves expensive equipment and numerous procedures, it requires precise process control. Usually, photolithography process is associated with products with relatively high deficiency rate and high manufacturing cost.

Further, another shortcomings for the traditional technology are that the cutting tools tend to wear out acceleratively due direct processing on mold core; and it is hard to achieve mirroring effect for tiny dot patterns by the processing method, which affects the optical properties.

In view of the above-mentioned shortcomings in the traditional technology, the inventor of the present invention has been dedicated to improvement and innovation, and after many years of research and development, finally has successfully completed the present invention of a method for manufacturing microlens light guide.

### SUMMARY OF THE INVENTION

The objective of the present invention is to provide a method for manufacturing microlens light guide, which is able to achieve the mirroring effect that is hard to obtain in the traditional processing method. The present invention uses thermal flow process to bring about dot mirroring effect and produce the finished products with excellent optical properties.

Another objective of the present invention is to provide a method for manufacturing microlens light guide, which uses simple equipment and fewer procedures with easy controllability to have a lower manufacturing cost than the traditional photolithography process.

Another objective of the present invention is to provide a method for manufacturing microlens light guide, which allows the easy formation of dots on a flat substrate.

The method that can achieve the above-mentioned objectives in the manufacturing of microlens light guide mainly consists of the procedures that include forming patterns, either in a concave or convex shape, on a plastic or wax mold substrate by mechanical processing, laser processing or other means, plasticizing the said patterns into microlens patterns by thermal flow, transferring the patterns on substrate to a metal mold by electroforming, and finally producing microlens light guide by injection molding or compression molding.

### BRIEF DESCRIPTION OF THE DRAWINGS

The drawings disclose an illustrative embodiment of the present invention that serves to exemplify the various advantages and objects hereof, and are as follows:

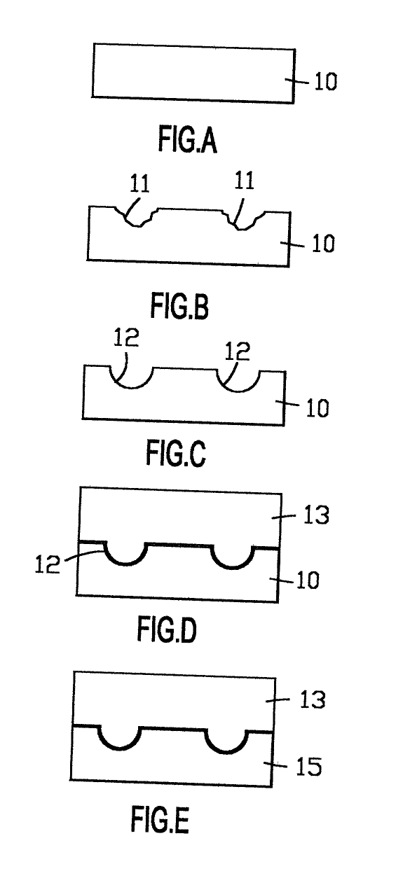

From FIG. 1A to FIG. 1E, it illustrates the process flow diagram for each procedure in the manufacturing of microlens light guide in the present invention.

### DETAILED DESCRIPTION OF THE PREFERRED EMBODIMENT

The method for manufacturing microlens light guide disclosed in the present invention mainly consists of the following procedures: (1) forming dot patterns, in either a concave or convex shape, on a flat substrate; (2) heating the flat substrate by thermal flow to plasticize the dot patterns to microlens patterns; (3) electroforming to transfer the microlens patterns on substrate to a mold for making microlens light guide.

To facilitate the plasticization of the dot patterns on substrate into microlens patterns as surface structure of microlens light guide, the flat substrate is selected from plasticizable materials like plastics or wax mold. The heating temperature for thermal flow depends on the plasticization temperature of the selected substrate material.

Processing methods, either traditional or non-traditional, such as mechanical processing or laser processing forms the dot patterns on the flat substrate.

With reference to the drawings from FIG. 1A to FIG. 1E, the illustrative process flow diagrams for a preferred embodiment in the present invention describe the procedures that include selecting a wax mold as the flat substrate 10 (as shown in FIG. 1A), forming patterns 11 (as shown in FIG. 1B) of numerous concave dots on the flat substrate 10 by laser processing, baking the flat substrate 10 with patterns 11 on surface in a heating equipment, such as an oven, until the concave dot patterns 11 being plasticized to microlens patterns 12 (as shown in FIG. 1C), cooling the flat substrate 12 with microlens patterns 12 to a suitable temperature, electroforming to transfer the microlens patterns 12 on the flat substrate 10 to a metal mold 13 that is used as the processing mold for the light guide, finally injection molding or compression molding to make microlens light guide 15.

Compared to the traditional photolithography, the method provided in the present invention for manufacturing microlens light guide features in simple equipment, less procedures, easy controllability and particularly low manufacturing cost. Besides, the method in the present invention can achieve the mirroring effect that is hard to obtain in the traditional method. Moreover, the present invention adopts thermal flow to transform dots into microlens patterns, so the finished products can acquire excellent optical properties. It should also be noted that the use of plastics or wax mold as the thermoplastic material for the flat substrate expedites the formation of dot patterns on the flat substrate.

Many changes and modifications in the above-described embodiment of the invention can, of course, be carried out without departing from the scope thereof. Accordingly, to promote the progress in science and the useful arts, the invention is disclosed and does not intend to be limited only by the scope of the appended claims.

What is claimed is:

1. A method for manufacturing microlens light guide, including:
forming dot patterns on a flat substrate;
baking said flat substrate to plasticize said dot patterns to microlens patterns through thermal flow;
electroforming to make said flat substrate as a processing mold; and
making said microlens light guide by use of said processing mold.

2. The method for manufacturing microlens light guide according to claim 1, wherein said flat substrate is made of wax mold.

3. The method for manufacturing microlens light guide according to claim 1, wherein said flat substrate is made of plastic materials.
